(19) United States
(12) Patent Application Publication
(10) Pub. No.: US 2011/0117245 A1
(43) Pub. Date: May 19, 2011

(54) DOUGH COMPOSITIONS FOR EXTENDED SHELF LIFE BAKED ARTICLES

(76) Inventors: Michael J. Engstrom, Minneapolis, MN (US); Cynthia Y. Drantch, Shorewood, MN (US); Jim O'Donnell, St. Louis Park, MN (US); Aimee Grimm, St. Louis Park, MN (US)

(21) Appl. No.: 13/010,902

(22) Filed: Jan. 21, 2011

Related U.S. Application Data
(63) Continuation of application No. 11/457,895, filed on Jul. 17, 2006.
(60) Provisional application No. 60/700,697, filed on Jul. 19, 2005.

(51) Int. Cl. A21D 10/02; A21D 8/04

(52) U.S. Cl. 426/62

(57) ABSTRACT

Dough compositions that can be baked to form baked articles having a desirable shelf life, for example about 3 days or greater, or about 7 days or greater, or about 14 days or greater are described. The dough compositions comprise: hard wheat flour; a leavening agent; sucrose; about 2% weight or greater of a pre-hydrated monoglyceride; about 4% weight or greater of a fat having a solid fat index (SFI) of: 0 to about 21 at 50° F.; 0 to about 16 at 70° F.; and 0 to about 12 at 92° F.; less than about 3% weight dextrose; less than about 10% weight corn syrup; less than about 3% weight glycerin; and less than about 10% weight soft wheat flour.

### CROSS-REFERENCES TO RELATED APPLICATIONS

This application claims the benefit of priority under 35 U.S.C. §119(e)(1) of a U.S. provisional patent application Ser. No. 60/700,697, filed Jul. 19, 2005, which is incorporated herein by reference in its entirety.

### FIELD

The invention relates to dough compositions that can be baked to provide baked articles having a desirable shelf life.

### BACKGROUND

Baked articles such as sweet rolls, muffins, cakes, pie crusts, doughnuts, and the like are typically made from dough compositions comprising flour, water, and leavening agents (e.g., yeast or a chemical leavening agent). After baking, the baked articles go through a change that makes them organoleptically less acceptable to consumers. This change is typically referred to as staling, and can include both flavor loss and loss of crumb softness. Staling occurs when the starch molecules crystallize or “retrograde.” Starch retrogradation refers to a process where molecules of gelatinized starch reassociate in an ordered structure. In the initial phase, two or more starch molecular chains form a simple juncture point that develops into more extensively ordered regions. Ultimately, this crystalline ordering causes the baked article to become stale.

Conventionally, preservatives and humectants have been used to retard staling and improve the shelf life of baked articles. Although these materials can be effective, improved dough compositions that can be baked to form baked articles having an extended shelf life are highly desirable.

### SUMMARY

The invention provides dough compositions that can be baked to form baked articles having a desirable shelf life, for example about 3 days or greater, or about 7 days or greater, or about 14 days or greater.

In one embodiment, the dough compositions comprises: hard wheat flour; a leavening agent (e.g., yeast, chemical leavening agents, or a combination thereof); sucrose; about 2% weight or greater of a pre-hydrated monoglyceride; about 4% weight or greater of a fat having a solid fat index (SFI) of 0 to about 21 at 50° F.; 0 to about 16 at 70° F.; and 0 to about 12 at 92° F.; less than about 3% weight dextrose; less than about 10% weight corn syrup; less than about 3% weight glycerin; and less than about 10% weight soft wheat flour.

In some embodiments, the dough composition comprises less than about 3% weight dextrose. In other embodiments, the dough composition contains less than about 10% weight corn syrup. In other embodiments, the dough composition contains less than about 3% weight glycerin. In yet other embodiments, the dough composition contains less than about 10% weight soft wheat flour.

The dough composition may comprises about 5% or greater of fat. In other embodiments, the dough composition comprises 6% or greater of fat. In yet other embodiments, the dough composition comprises about 7% or greater of fat.

The fat may comprise about 3% or greater soybean oil or about 4% or greater solid margarine. In an exemplary embodiment, the fat comprises about 3% or greater soybean oil and about 4% or greater solid margarine.

In some embodiments the is a mixture of soybean oil and solid margarine having a solid fat index (SFI) of about 15 at 50° F.; about 11.5 at 70° F.; and about 8.5 at 92° F.

In an exemplary embodiment, the dough composition comprises about 50% weight hard wheat flour; about 17% to about 32% weight water; about 3% to about 5% weight yeast; about 3% weight soybean oil, about 4% weight solid margarine, about 3% to 5% weight monoglyceride; about 2% to about 9% weight granulated sucrose; about 2% egg; about 1% weight leavening acid; about 1% weight leavening base.

In another aspect, the invention provides a baked article formed from the dough composition of the invention. In some embodiments, the baked article is a cinnamon roll which may be laminated or may be non-laminated.

In another aspect, the invention provides a process for making a dough composition that can be baked to provide a baked article having an extended shelf life, the process comprising:
(a) forming a mixture comprising: hard wheat flour; yeast; about 2% weight or greater of a pre-hydrated monoglyceride; a first portion of a fat having a solid fat index (SFI) of: 0 to about 21 at 50° F.; 0 to about 16 at 70° F.; and 0 to about 12 at 92° F.;
(b) developing the mixture (i.e., the gluten in the flour) to provide a developed dough composition;
(c) adding to the developed composition of (b): sucrose; salt; a chemical leavening agent; and a second portion of a fat having a solid fat index of: 0 to about 21 at 50° F.; 0 to about 16 at 70° F.; and 0 to about 12 at 92° F.; and
(d) mixing the ingredients added in step (c) with the developed composition in step (b) to form the dough composition of the invention.
   The method of the invention, being conducted in two stages, allows for the full development of the gluten network in stage 1 (i.e., step (a)) without interference from the components in Stage 2 (i.e., step (c)) as these components may compete with the flour for interaction with water. The water in the dough composition is managed to maximize development of the dough composition.

As used herein, the following terms have the following meaning:

“Baked article” refers to an article that is formed by baking a dough composition. A baked article of the invention is formed by baking a dough composition of the invention. Examples of baked articles include cinnamon rolls, doughnuts, and the like.

“Shelf-life” refers to the shelf life of a baked article after baking. A shelf life of a given number of days (e.g., 7 days) refers to the number of days, after baking, that the baked article substantially retains its initial flavor profile and texture characteristics.

### DETAILED DESCRIPTION

The invention is now illustrated in greater detail by way of the following detailed description, but it should be understood that the invention is not to be construed as being limited thereto.

The invention provides dough compositions that can be baked to form baked articles having a desirable shelf life. Dough compositions of the invention have been formulated to provide baked articles (e.g., cinnamon rolls) that have a desirable shelf life (e.g., 7 days or greater or 14 days or greater) through the selective inclusion of certain ingredients that may extend shelf life, along with the selective reduction or elimination of certain other ingredients that may shorten shelf life.

In some embodiments, the dough compositions comprises: hard wheat flour; a leavening agent (e.g., yeast, chemical leavening agents, or a combination thereof); sucrose; about 2% weight or greater of a pre-hydrated monoglyceride; about 4% weight or greater of a fat having a solid fat index (SFI) of: 0 to about 21 at 50° F.; 0 to about 16 at 70° F.; and 0 to about 12 at 92° F.; less than about 3% weight dextrose; less than about 10% weight corn syrup; less than about 3% weight glycerin; and less than about 10% weight soft wheat flour.

Dough compositions of the invention comprise hard wheat flour. As used herein the term “hard wheat flour” refers to wheat flour having a medium to high protein content, for example, ranging from about 11% to about 16% by weight protein, more typically ranging from about 11.5% to about 12.5% by weight protein. Hard wheat flour may include for example, hard red winter, hard red spring, and hard white. In some embodiments, the hard wheat flour is enriched with vitamins and/or minerals. Useful wheat hard wheat flours may be identified, for example, as “Enriched Malted Hard Spring Flour”, “Bread Flour”, “Enriched Flour”, or “Hard Spring/Winter Blend” and are available, for example, from New Life Mills LTD, Horizon Milling LLC, Mennel Milling Co., Cargill, Incorporated, or ADM Milling.

Dough compositions of the invention comprise hard wheat flour and may optionally include one or more other types of flour. Optionally, the hard wheat flour may be combined with one or more other types of flour in order to provide the composition with other desirable attributes, for example, desirable textural characteristics, nutritional values, and the like. Representative examples of other flours include rye flour and oat flour. In some embodiments, vital wheat gluten may also be added to the flour in order to supplement the lower levels of protein in some flours. Vital wheat gluten may be obtained commercially under the trade designations “PROVIM ESP WHEAT GLUTEN” from ADM Food Ingredients; “GEM OF THE WEST WHEAT GLUTEN (from Manildra Milling Corp.; “VITAL WHEAT GLUTEN” (from MGP Ingredients) and from American Yeast Sales.

Dough compositions of the invention typically comprise about 40% to about 56% weight hard wheat flour based on the total weight of the dough composition. In an exemplary embodiment, the dough composition comprises about 50% weight flour. If a second flour is used, the second flour (or mixture of flours) is typically added in an amount ranging from about 5% to about 20% weight based on the total weight of the dough composition. If present, vital wheat gluten is typically added in an amount ranging from about 1% to about 5% by weight.

Dough compositions of the invention comprise at least one monoglyceride that is hydrated (i.e., dissolved in water) before it is added to the dough composition. A monoglyceride that is hydrated before addition to the dough composition may be referred to as “pre-hydrated” indicating that the hydration occurs before addition to the dough composition. By pre-hydrating the monoglyceride, it does not compete with the gluten in the flour for the available water during the development of the dough composition. This facilitates the formation of a fully developed gluten network.

Monoglycerides are glycerol esters of fatty acids in which one acid group of the fatty acid is esterified. Monoglycerides may be represented by the general chemical formula:

CH₂OH—CH(O)OR—CH₂OH
where —R is an alkyl group.

Examples of monoglycerides include glycerol monostearate and glycerol monolaurate. The pre-hydrated monoglyceride is typically provided in a solution of about 40% to about 60% weight in water. Monoglycerides can be pre-hydrated by methods known to those of skill in the art.

In some embodiments, the pre-hydrated monoglyceride is included in the dough composition in an amount ranging from about 2% to about 6% by weight, in other embodiments from about 3% to 4% by weight. In an exemplary embodiment, the monoglyceride is present at 3.5% by weight.

Monoglycerides may be obtained commercially, for example, under the trade designations “GMS-90 DOUBLE STRENGTH” (prehydrated monoglyceride from American Ingredients Co.); “DIMODAN HS K-A 810773” (distilled monoglyceride from Danisco); “DUR-EM 114 (mono and diglyceride from Loders Croklaan); “BFP 65K #005” (Alpha monoglycerides from American Ingredients Co.); “LONZA'S ALDOSPERSE MS-20” (ethoxylated monoglyceride from Mays Chemical Co.).

Dough compositions of the invention comprise sucrose as a sweetener. Sucrose has been chosen to provide food for the yeast, desired sweetness, and in order to minimize the competition for water. The sucrose may be added in solid form (i.e., fine or standard granulated) or in liquid form. Typically, the dough composition comprises about 2% to about 8% weight sucrose. Sucrose may be obtained commercially under the trade designation “EXTRA FINE GRANULATED” (from American Sugar Refining Co.); “WHITE SATIN SUGAR” (from Amalgamated Sugar Co.); and “GRANULAR SUGAR” (from Cargill, Inc.).

Dough compositions of the invention comprise a fat having a specified solid fat index (SFI). Solid fat index is an empirical value that is derived from the expansion of a sample of the fat. Test measurements are made with dilatometers; specialized vessels with a bulb and a precision graduated capillary tubing. To measure SFI, a fat sample is first tempered by immersing the sample into successive constant temperature baths at 60° C., 40° C., 27° C., and 0° C. Tempering places a specific thermal history into the sample and allows the fat to crystallize under controlled conditions. The sample is then immersed for 30 minutes in baths at various increasing temperatures (e.g., 50° F., 70° F., 80° F., 92° F., and 100° F.) and the volume is measured at each temperature using a dilatomer. In the process of melting, previously crystallized portions of the sample become liquefied. Since the fat molecules in a liquid state are less efficiently arranged in space as compared to closely packed crystalline regions, the liquid fat takes up more volume than the solid fat. Therefore, the degree of expansion is related to the change in the solid fat content. The volume versus temperature response for the fat gives the SFI values at different temperatures. Dough compositions of the invention comprise a fat that has a solid fat index (SFI) of 0 to about 21 at 50° F.; 0 to about 16 at 70° F.; and 0 to about 12 at 92° F. In some embodiments, the dough compositions of the invention comprise a fat that has a solid fat index (SFI) of about 10 to about 18 at 50° F.; about 8 to about 13 at 70° F.; and about 5 to about 10 at 92° F. In a specific embodiment, the SFI of the fat is about 15 to about 16 at 50° F.; about 11 to about 12 at 70° F.; and about 8 to about 9 at 92° F.

The fat component can be selected from oils and shortenings. Examples of such oils can include oil ingredients from vegetable, dairy and marine sources including butter oil or butterfat, soybean oil, corn oil, rapeseed or canola oil, copra oil, cottonseed oil, fish oil, safflower oil, olive oil, sunflower oil, peanut oil, palm oil, palm kernel oil, coconut oil, rice bran oil and other plant derived oils such as vegetable or nut oils. Examples of shortenings include animal fats such as lards, butter and hydrogenated vegetable oils such as margarine. Mixtures of different fats may also be used.

In some embodiments, the fat comprises a mixture of about 3% weight or greater soybean oil and about 4% weight or greater solid margarine (e.g., hydrogenated soy cottonseed). In an exemplary embodiment, the fat comprises about 3% weight soybean oil and about 4% weight solid margarine. In an exemplary embodiment, the fat comprises about 3% weight soybean oil and about 4% weight solid margarine having an SFI of about 15.1 at 50° F.; about 11.4 at 70° F.; and about 8.6 at 92° F.

Dough compositions can be caused to expand (leaven) by any leavening mechanism, such as by one or more of the effects of: entrapped gas such as entrapped carbon dioxide, entrapped oxygen, or both; by action of chemical leavening agents; or by action of a biological agent such as a yeast. Thus, a leavening agent may be an entrapped gas such as layers or cells (bubbles) that contain carbon dioxide, water vapor, or oxygen, etc.; any type of yeast (e.g., cake yeast, cream yeast, dry yeast, etc.); or a chemical leavening system (e.g., containing a basic chemical leavening agent and an acidic chemical leavening agent that react to form a leavening gas such as carbon dioxide). As used herein the term “yeast leavened” refers to dough compositions that are leavened primarily due to the production of gaseous metabolited by yeast; chemical leavening agents may optionally be present, but in minor amounts, preferably less than about 10% by weight chemical leavening agent based on the total weight of the leavening agent (yeast and chemical leavening agent) or may not be present at all.

Yeast is included to produce gaseous metabolites (e.g., carbon dioxide) that cause the dough composition to rise. The yeast may be any suitable yeast known to those of skill in the art, for example, fresh cream/liquid yeast, fresh compressed yeast, active dry yeast, and instant yeast. In some embodiments, the yeast is fresh compressed yeast (e.g., in cake or crumbled form) comprising about 65% to about 75% water and about 25% to about 35% yeast. The amount of yeast can be an amount that will produce a desired volume of gaseous metabolites, as known to one of skill in the art. Typically, the amount of yeast added to the dough composition ranges from about 1% to 7% weight based on the total weight of dough composition.

In some embodiments a chemical leavening agent is used in addition to yeast. If present, a chemical leavening agent typically comprises a leavening acid and a leavening base. Leavening acids include, for example, sodium aluminum phosphate, sodium acid pyrophosphate, and GDL. When present, leavening acids are typically included in an amount ranging from about 0.4% to 1.5% weight. Leavening bases include, for example, sodium bicarbonate, encapsulated sodium bicarbonate, AMCP, and MCP. When present, leavening bases are typically present in an amount ranging from about 0.6% to 1.7% weight.

Dough compositions of the invention typically comprise a minimal amount or no glycerin (also commonly known as glycerol or 1,2,3-propanetriol). Glycerin is a colorless, viscous, hygroscopic liquid that is sometimes used in food as a moisture-retaining agent. Glycerin has been minimized or eliminated from the dough composition of the invention, as it is believed to negatively affect the shelf life of the baked articles. In some embodiments, the dough composition comprises less than about 3% weight glycerin (e.g., less than about 2%, less than about 1%, less than about 0.1% weight glycerin). In an exemplary embodiment, the dough composition comprises no glycerin.

Dough compositions of the invention typically comprise a minimal amount or no dextrose (also known as glucose). Dextrose has been reduced or eliminated from the dough composition of the invention, as it is believed that dextrose negatively affects the shelf life of baked articles. In some embodiments, the dough compositions comprise less than about 3% weight dextrose. In other embodiments, the dough composition comprises less than about 2% weight dextrose (e.g., less than about 1%, or less than about 0.1% weight dextrose). In an exemplary embodiment, the dough composition comprises no dextrose.

Dough compositions of the invention include a minimal amount of corn syrup since it may negatively affects the shelf life of baked articles. Corn syrup may be characterized by its dextrose equivalent (DE), which relates to the extent of hydrolysis undergone by the starch (i.e., the reducing sugar content calculated as dextrose and expressed as a percent of the total dry substance). The DE of corn syrup typically ranges from about 20 to about 42 for low conversion corn syrup, and about 42 or greater for high conversion corn syrup. As the DE of corn syrup increases, the corn syrup has generally been found to be more deleterious to the shelf life of the baked article. That is, as the DE increases, less corn syrup can be tolerated in the dough composition if extended shelf life is desired. Another type of corn syrup is high fructose corn syrup. High fructose corn syrup is obtained by the conversion of glucose present in regular corn syrup into fructose, typically by the use of an alkaline catalyst or by an enzymatic process. High fructose corn syrup typically contains levels of fructose ranging from about 42% to about 90% on a dry basis.

In one embodiment of the invention, the dough composition comprises less than about 10% of high DE corn syrup (i.e., having a DE of about 42 or greater). In another embodiment, the dough composition comprises less than about 20% low DE corn syrup (i.e., DE of less than about 42). In another embodiment, the dough composition comprises less than about 5% weight corn syrup (e.g., less about 4%, less than about 3%, less than about 2%, less than about 1%, or less about 0.1% weight corn syrup). In an exemplary embodiment, the dough composition comprises no corn syrup.

Dough compositions of the invention typically comprise a minimal amount of soft wheat flour. As used herein the term “soft wheat flour” refers to wheat flour with a low protein content, for example, ranging from about 5% to about 9% weight protein, more typically about 8% weight protein. In some embodiments, dough compositions of the invention comprise less than about 10% weight soft wheat flour (e.g., less than about 5%, less than about 4%, less than about 3%, less than about 2%, less than about 1%, or less than about 0.1% weight soft wheat flour). In an exemplary embodiment, the dough composition comprises no soft wheat flour.

Dough compositions of the invention typically include one or more liquid components, for example, water, milk, eggs, and oil, or any combination of these.

Water may be added during processing in the form of ice, to control the dough temperature in process; the amount of any such water used is included in the amount of liquid components. The amount of liquid components included in any particular dough composition can depend on a variety of factors including the desired moisture content of the dough composition. Typically, liquids are present in a dough composition in an amount up to about 40% by weight (e.g., about 20% to about 37% by weight).

The dough composition may optionally include an egg product (e.g., for flavoring). Examples of egg products include fresh eggs, egg substitutes, dried egg products, frozen egg products, etc. The amount of egg products, if used, is typically about 0.1% to about 3% weight (e.g, about 2% weight). The egg products may be in a dried form or a liquid form. If a liquid form of egg product is used, the amount of liquid component is adjusted to take into account the moisture content resulting from the liquid egg product.

The dough composition may optionally include dairy products (e.g., dairy protein, milk, buttermilk, or other milk products) in either dried or liquid form. Alternatively, milk substitutes such as soy milk may be used. If used, dairy products may be included up to about 8% by weight of the dough composition, e.g., between about 1% weight and about 4% weight of the dough composition. If a dried dairy product is used, it is not considered to be a part of the liquid component identified above; if a liquid form of a dairy product is used, the amount of other liquid components, if any, can be adjusted accordingly.

The dough composition may optionally include additional flavorings such as salt (e.g., NaCl, KCl), whey; malt; yeast extract; inactivated yeast; spices; and flavorings (e.g., vanilla, butter, lemon, yeast, etc.) as is known in the dough product arts. The additional flavoring can typically be included in an amount in the range from about 0.1 weight percent to about 10% weight of the dough composition, more typically from about 0.1% to about 5% weight.

The dough composition may optionally include particulates such as raisins, currants, fruit pieces, nuts, seeds, vegetable pieces, and the like, in suitable amounts.

The dough composition may optionally include other additives, colorings, and processing aids such as emulsifiers include lecithin, mono- and diglycerides, polyglycerol esters, and the like, e.g., diacetylated tartaric esters of monoglyceride (DATEM) and sodium stearoyl lactylate (SSL).

An exemplary dough composition of the invention is set forth in TABLE 1.

TABLE 1

| INGREDIENT | AMOUNT (% weight) |
|---|---|
| Hard wheat flour | 51% |
| Water | 20% |
| Yeast | 4% |
| Egg | 1.7% |
| Flavor | 1% |
| Margarine | 4% |
| Soybean Oil | 3% |
| Salt | <1% |
| Sucrose | 8% |
| Emulsifier | 1% |
| Azodicarbonamide | <1% |
| Premix | |
| Ascorbic Acid | <1% |
| Leavening Acids | about 1% |
| Leavening Bases | about 1% |

In some embodiments, the dough compositions of the invention are formed into baked articles that are non-laminated. As is known to those of skill in the art, the term “laminated” refers to a baked article that has discrete layers of dough that are separated from by discrete layers of fat. Non-laminated baked articles do not include such a layered structure and are typically formed of a single mass of the dough composition that has been baked. In an exemplary embodiment, the baked article is a non-laminated cinnamon roll comprising a baked portion of the dough composition of the invention and a cinnamon smear. The cinnamon smear is applied to the surface of the dough composition before it is rolled up. A representative cinnamon smear is commercially available from Dawn Foods Products (Item No. 00014597) and typically comprises, inter alia, fat, sugar, and cinnamon.

In some embodiments, the dough compositions of the invention can be made into a baked article having an desirable shelf life, for example, in some embodiments about 3 days or greater; in other embodiments about 7 days or greater; an in other embodiments about 14 days or greater.

In another aspect, the invention provides a method of making a dough composition that can be baked to provide a baked article having a desirable shelf life. In one embodiment, the process of the invention comprises a two-stage mixing process wherein the first stage comprises forming a mixture comprising hard wheat flour, water, yeast (if included in the formulation), pre-hydrated monoglyceride, and a first portion of a fat having a solid fat index of about has a solid fat index (SFI) of 0 to about 20 at 50° F.; 0 to about 16 at 70° F.; and 0 to about 13 at 92° F.

The ingredients in the first stage are mixed to form a developed composition. Dough compositions commonly referred to as “developed” are generally understood to include those that have a relatively highly-developed gluten matrix structure; a stiff, elastic rheology; and (due to the stiff, elastic matrix) are able to form bubbles or cells that can stretch without breaking to hold a leavening gas while the dough composition expands, leavens, or rises, prior to or during cooking (e.g., baking). Features that may be associated with a developed dough composition, in addition to a stiff, elastic rheology, include a liquid content (e.g., water content) that is relatively high compared to under-developed dough compositions; a sufficient (e.g., relatively high) protein content to allow for a highly-developed structure; optionally, processing steps that include time to allow the dough-forming ingredients to interact and develop to strengthen the dough.

The ingredients may be mixed using a mixer, such as model HM100HS (from Peerless Machinery Corp.). Typically, using such a mixer, the ingredients will be mixed at a speed and time suitable for fully developing the dough. For example, the ingredients can be mixed on low speed (e.g., 36 RPM) for about 1 minute or less (e.g., 30 seconds) and then mixed on high speed (e.g., 72 RPM) for about 5 to 10 minutes (e.g., 8 minutes). These times and speeds are illustrative and can vary depending upon such factors as the amount of dough composition being mixed and the type of mixer. During mixing, the dough composition can be maintained at a desired temperature, for example, about 62° F. to 75° F. To maintain the desired temperature, the added water can be chilled or provided in the form of ice or ice and water.

After forming a developed composition, the second stage ingredients are added. The second stage ingredients include, for example, sucrose, salt, chemical leavening agents, and a second portion of fat as described above. Typically, the first and the second portions of fat are approximately equal in weight to each other. In some embodiments, the first portion of fat and the second portion of fat provide a total fat content of about 4% weight or greater based on the total weight of the dough composition. In other embodiments, the first and second portions provide a total fat content of about 5% weight or greater or about 6% weight or greater, or about 7% weight or greater. After adding the second stage ingredients, the dough ingredients are mixed to form a dough composition of the invention. Typically, the second stage ingredient will be mixed into the first stage ingredients on low speed (e.g., 36 RPM) for less than about 1 minute (e.g., 30 seconds) followed by mixing on high speed (e.g., 72 RPM) for about 1 to 4 minutes (e.g., 3 minutes). After mixing, the dough composition desirably has a temperature of about 68° F.±2° F.

Once the dough composition has been prepared, it can be further processes according to known methods of forming a dough composition into a desired size and shaped, followed by other processing steps, for example, packaging, freezing, and cooking. A variety of techniques can be used for processing. For example, processing of the dough composition can include one or more of sheeting, extruding, dividing, rounding, etc.

In an exemplary embodiment, the dough composition is transferred into a sheeted dough line (e.g., of the type commercially available from Rykaart, Moline, or Rheon) and is sheeted to a thickness of about 2.5 to about 6 mm. After sheeting, a cinnamon smear is then applied to the sheeted dough composition, typically at about 8% to 30% weight of total composition. The sheet is then rolled up to form a log, for example, having a diameter of about 0.75 to about inches. The log is then cut into individual cinnamon rolls having cut lengths ranging from about 0.5 to about 3 inches. The cut log may then be frozen (e.g., at a temperature below about 0° F.).

Additional dough compositions having an enhanced shelf life are described in U.S. Provisional Patent Application entitled “DOUGH COMPOSITIONS AND BAKED ARTICLES MADE THEREFROM” and bearing Attorney Docket No. GMI0035P1; filed Jul. 19, 2005.

The present invention will be described below with reference to the following representative examples, wherein unless otherwise indicated; all percentages are weight percentages based upon the total weight of the dough composition. Furthermore, although the following examples illustrate the invention by the description of the production of cinnamon rolls, other dough products are also within the scope of the invention, for example, doughnuts, Danishes, toaster pastries, coffeecakes, sweet rolls, Bismarcks, cookies, bagels, biscuits, scones, dinner rolls, breads, croissants, egg twists, bread sticks, and the like.

### EXAMPLES

Examples 1-18 were prepared as follows using the ingredients listed in TABLES 2-5. A 50 lb. horizontal bar mixer (Peerless, Model No. HM-100-HS) was charged with water/ice sufficient to make a 50 lb. batch. Next, the dry minors, yeast, and flour of Charge 1 were preblended and were added to the mixer. Next, the fats (i.e., soybean oil and margarine) of Charge 1 were added to the mixer. The ingredients were then mixed for about 30 seconds at 36 RPM, followed by 8 minutes at 72 RPM. Next, the ingredients from Charge 2 were added to the mixer. The ingredients were mixed for about 30 seconds at 36 RPM, followed by 3 minutes at 72 RPM.

The completed dough composition was divided into 6000 gram pieces. Each dough piece was sheeted down to about 5 mm in thickness. Next, the dough piece was 3-folded and was turned 90 degrees. The dough piece was again sheeted down to about 5 mm in thickness. The dough piece was then transferred to a floured make-up table where it was cross-sheeted with a rolling pin to a width of about 12 inches. Next, about 820 grains of cinnamon smear was applied to the surface of the dough sheet and the dough sheet was rolled up. Individual rolls having a height of about 1.2 inches and a target weight of about 81 grams were cut from the rolled-up sheet.

TABLE 2

| | Ex. 1 | Ex. 2 | Ex. 3 | Ex. 4 | Ex. 5 |
|---|---|---|---|---|---|
| | % wt. | % wt. | % wt. | % wt. | % wt. |
| CHARGE 1 | | | | | |
| Flour | 51.1 | 51.1 | 51.1 | 51.1 | 51.1 |
| Water | 20.2 | 20.2 | 20.2 | 20.2 | 20.2 |
| Bakers Yeast | 4.0 | 4.0 | 4.0 | 4.0 | 4.0 |
| Whole Egg | 1.7 | 1.7 | 1.7 | 1.7 | 1.7 |
| Vanilla Flavor | <1 | <1 | <1 | <1 | <1 |
| Margarine | 2.0 | 2.0 | 4.0 | 0 | 1.0 |
| Azodicarbonamide Premix | <1 | <1 | <1 | <1 | <1 |
| Ascorbic Acid Tablets | <1 | <1 | <1 | <1 | <1 |
| Emulsifier | 1.0 | 1.0 | 1.0 | 1.0 | 1.0 |
| Monoglyceride Hydrate | 3.5 | 0.25 | 0.25 | 0.25 | 0.25 |
| Soybean Oil | 1.5 | 2.0 | 0 | 4.0 | 1.0 |
| CHARGE 2 | | | | | |
| Margarine | 2.0 | 2.0 | 4.0 | 0 | 1.0 |
| Granulated Sugar | 8.0 | 8.0 | 8.0 | 8.0 | 8.0 |
| Salt | 0.85 | 0.85 | 0.85 | 0.85 | 0.85 |
| Soybean Oil | 1.5 | 1.5 | 0 | 4.0 | 1.0 |
| SAP | <1 | <1 | <1 | <1 | <1 |
| Glucono Delta Lactone #2 | <1 | <1 | <1 | <1 | <1 |
| Encapsulated Sodium | <1 | <1 | <1 | <1 | <1 |
| Bicarbonate | | | | | |
| Sodium Bicarbonate | <1 | <1 | <1 | <1 | <1 |

TABLE 3

| | Ex. 6 | Ex. 7 | Ex. 8 | Ex. 9 | Ex. 10 |
|---|---|---|---|---|---|
| | % wt. | % wt. | % wt. | % wt. | % wt. |
| CHARGE 1 | | | | | |
| Flour | 51.1 | 51.1 | 51.1 | 51.1 | 51.1 |
| Water | 20.2 | 20.2 | 20.2 | 20.2 | 20.2 |
| Bakers Yeast | 4.0 | 4.0 | 4.0 | 4.0 | 4.0 |
| Whole Egg | 1.7 | 1.7 | 1.7 | 1.7 | 1.7 |
| Flavor | <1 | <1 | <1 | <1 | <1 |
| Margarine | 2.0 | 0 | 2.0 | 4.0 | 0 |
| Azodicarbonamide Premix | <1 | <1 | <1 | <1 | <1 |
| Ascorbic Acid Tablets | <1 | <1 | <1 | <1 | <1 |
| Emulsifier | 1.0 | 1.0 | 1.0 | 1.0 | 1.0 |
| Monoglyceride Hydrate | 0.25 | 0.25 | 3.5 | 3.5 | 3.5 |
| Soybean Oil | 0 | 2.0 | 2.0 | 0 | 4.0 |
| CHARGE 2 | | | | | |
| Margarine | 2.0 | 0 | 2.0 | 4.0 | 0 |
| Granulated Sugar | 8.0 | 8.0 | 8.0 | 8.0 | 8.0 |
| Salt | <1 | <1 | <1 | <1 | <1 |
| Soybean Oil | 0 | 2.0 | 2.0 | 0 | 4.0 |
| SAP | <1 | <1 | <1 | <1 | <1 |
| Glucono Delta Lactone #2 | <1 | <1 | <1 | <1 | <1 |
| Encapsulated Sodium | <1 | <1 | <1 | <1 | <1 |
| Bicarbonate | | | | | |
| Sodium Bicarbonate | <1 | <1 | <1 | <1 | <1 |

TABLE 4

| | Ex. 11 | Ex. 12 | Ex. 13 | Ex. 14 | Ex. 15 |
|---|---|---|---|---|---|
| | % wt. | % wt. | % wt. | % wt. | % wt. |
| CHARGE 1 | | | | | |
| Flour | 51.1 | 51.1 | 51.1 | 51.1 | 51.1 |
| Water | 20.2 | 20.2 | 20.2 | 20.2 | 20.2 |
| Bakers Yeast | 4.0 | 4.0 | 4.0 | 4.0 | 4.0 |
| Whole Egg | 1.7 | 1.7 | 1.7 | 1.7 | 1.7 |
| Flavor | <1 | <1 | <1 | <1 | <1 |
| Margarine | 1.0 | 2.0 | 0 | 0 | 1.0 |
| Azodicarbonamide Premix | <1 | <1 | <1 | <1 | <1 |
| Ascorbic Acid Tablets | <1 | <1 | <1 | <1 | <1 |
| Emulsifier | 1.0 | 1.0 | 1.0 | 1.0 | 1.0 |
| Monoglyceride Hydrate | 3.5 | 3.5 | 3.5 | 0.25 | 0.25 |
| Soybean Oil | 1.0 | 0 | 2.0 | 4.0 | 1.0 |
| CHARGE 2 | | | | | |
| Margarine | 1.0 | 2.0 | 0 | 0 | 1.0 |
| Granulated Sugar | 8.0 | 8.0 | 8.0 | 8.0 | 8.0 |
| Salt | <1 | <1 | <1 | <1 | <1 |
| Soybean Oil | 1.0 | 0 | 2.0 | 4.0 | 1.0 |
| SAP | <1 | <1 | <1 | <1 | <1 |
| Glucono Delta Lactone #2 | <1 | <1 | <1 | <1 | <1 |
| Encapsulated Sodium | <1 | <1 | <1 | <1 | <1 |
| Bicarbonate | | | | | |
| Sodium Bicarbonate | <1 | <1 | <1 | <1 | <1 |

TABLE 5

| | Ex. 16 | Ex. 17 | Ex. 18 |
|---|---|---|---|
| | % wt. | % wt. | % wt. |
| CHARGE 1 | | | |
| Flour | 51.1 | 51.1 | 51.1 |
| Water | 20.2 | 20.2 | 20.2 |
| Bakers Yeast | 4.0 | 4.0 | 4.0 |
| Whole Egg | 1.7 | 1.7 | 1.7 |
| Flavor | <1 | <1 | <1 |
| Margarine | 2.0 | 1.0 | 0 |
| Azodicarbonamide Premix | <1 | <1 | <1 |
| Ascorbic Acid Tablets | <1 | <1 | <1 |
| Emulsifier | 1.0 | 1.0 | 1.0 |
| Monoglyceride Hydrate | 3.5 | 0.25 | 0.25 |
| Soybean Oil | 1.5 | 1.0 | 2.0 |
| CHARGE 2 | | | |
| Margarine | 2.0 | 1.0 | 0 |
| Granulated Sugar | 8.0 | 8.0 | 8.0 |
| Salt | <1 | <1 | <1 |
| Soybean Oil | 1.5 | 1.0 | 2.0 |
| SAP | <1 | <1 | <1 |
| Glucono Delta Lactone #2 | <1 | <1 | <1 |
| Encapsulated Sodium | <1 | <1 | <1 |
| Bicarbonate | | | |
| Sodium Bicarbonate | <1 | <1 | <1 |

Sensory results were obtained by a panel of research and development and sensory scientists tasting the example cinnamon rolls and agreeing on a numerical listing for each example. Moisture results were rated negative for perceptively dryer examples and positive for moister examples relative to Example 1. The hardness column was rated negative for softer examples and positive for harder examples relative to Example 1. The results are set forth in TABLES 6-8.

TABLE 6
Day 1-Unheated

| Example No. | Moisture | Hardness |
|---|---|---|
| 1 | 0 | 0 |
| 2 | −1 | −1 |
| 3 | 0 | 0 |
| 4 | −0.5 | 0 |
| 5 | −1 | 0.5 |
| 6 | −1 | 0 |
| 7 | 0 | 0 |
| 8 | 1 | 0 |
| 9 | −0.5 | 0 |
| 10 | 0 | 0 |
| 11 | 1 | 0 |
| 12 | 0 | 0 |
| 13 | −1 | 0 |
| 14 | 0 | 0 |
| 15 | −1 | 0 |
| 16 | 0 | 0 |
| 17 | 0 | 0 |
| 18 | 0.5 | 0 |

TABLE 7
Day 4-Unheated

| Example No. | Moisture | Hardness |
|---|---|---|
| 1 | 0 | 0 |
| 2 | 1 | 0 |
| 3 | 0.5 | 0 |
| 4 | 0 | 0 |
| 5 | −0.5 | 0 |
| 6 | −0.5 | 0 |
| 7 | −0.5 | 0 |
| 8 | 0 | 0 |
| 9 | 0.5 | 0 |
| 10 | 0 | 0 |
| 11 | 0 | 0 |
| 12 | 0 | 0 |
| 13 | 0.5 | 0 |
| 14 | 0 | 0 |
| 15 | −1 | 0 |
| 16 | 0 | 0 |
| 17 | 0.5 | 0 |
| 18 | 0 | 0 |

TABLE 8
Day 4-Heated

| Example No. | Moisture | Hardness |
|---|---|---|
| 1 | 0 | 0 |
| 2 | 0.5 | −0.5 |
| 3 | NA | NA |
| 4 | NA | NA |
| 5 | 0 | 0 |
| 6 | 0.5 | 0 |
| 7 | NA | NA |
| 8 | 1 | 0 |
| 9 | 0 | 0 |
| 10 | −0.5 | 0 |
| 11 | 1 | 0 |
| 12 | NA | NA |
| 13 | NA | NA |
| 14 | NA | NA |
| 15 | 0 | 0 |
| 16 | 0.5 | 0 |
| 17 | 1 | 0 |
| 18 | 0 | 0 |

Bread firmness measurements were made on Examples 1-18 using a procedure adapted from AACC Method 74-09. A TA.TX Texture Analyzer (from Texture Technologies Corp.) equipped with a 40 mm diameter compression plunger was used. A flat base plate was placed under the plunger. The distance between the plunger and the base plate was 26 mm. Sample B was heated for 16 seconds using a microwave oven Model No. JE216SF01 (General Electric Profile series from General Electric Co.). The sample was then allowed to stand for one minute. Sample A was at room temperature. A portion of the top of each sample was cut off using a serrated knife so that the sample had a height of 25 mm+/−1 mm. The sample was then centered under the plunger and the compression cycle was initiated using a crosshead speed of 1.67 mm/sec and a compression distance of 16 mm. The compression force value was recorded after 6.25 mm of compression. The slope of the initial portion of the force curve was also recoded. Replicate samples were run for each Example No. The data is reported in TABLE 9.

TABLE 9

| | Replicate | Sample A | | Sample B | |
|---|---|---|---|---|---|
| Batch # | # | CFW | Slope 1 | CFW | Slope 1 |
| Control | 1 | 3050 | 1310 | 1140 | 462 |
| | 2 | 2770 | 1310 | 1050 | 425 |
| | Avg. | 2910 | 1310 | 1095 | 444 |
| 2 | 1 | 2940 | 1450 | 1280 | 451 |
| | 2 | 2130 | 1050 | 852 | 322 |
| | Avg. | 2535 | 1250 | 1066 | 387 |
| 3 | 1 | 3730 | 1550 | 1030 | 459 |
| | 2 | 3170 | 1950 | 1180 | 633 |
| | Avg. | 3450 | 1750 | 1105 | 546 |
| 4 | 1 | 3530 | 1420 | 1420 | 692 |
| | 2 | 3410 | 1660 | 1250 | 532 |
| | Avg. | 3470 | 1540 | 1335 | 612 |
| 5 | 1 | 3160 | 1390 | 1550 | 724 |
| | 2 | 3190 | 1340 | 1330 | 622 |
| | Avg. | 3175 | 1365 | 1440 | 673 |
| 6 | 1 | 3870 | 2460 | 1340 | 630 |
| | 2 | 2870 | 1530 | 1420 | 757 |
| | Avg. | 3370 | 1995 | 1380 | 694 |
| 7 | 1 | 4440 | 3060 | 1520 | 841 |
| | 2 | 3280 | 1850 | 1670 | 868 |
| | Avg. | 3860 | 2455 | 1595 | 855 |
| 8 | 1 | 2670 | 1110 | 905 | 262 |
| | 2 | 3870 | 2010 | 988 | 351 |
| | Avg. | 3270 | 1560 | 947 | 307 |
| 9 | 1 | 3770 | 1790 | 1290 | 570 |
| | 2 | 3720 | 1590 | 760 | 355 |
| | Avg. | 3745 | 1690 | 1025 | 462.5 |
| 10 | 1 | 3040 | 1170 | 1160 | 534 |
| | 2 | 2880 | 940 | 1280 | 562 |
| | Avg. | 2960 | 1055 | 1220 | 548 |
| 11 | 1 | 2520 | 1120 | 823 | 371 |
| | 2 | 2780 | 1390 | 951 | 440 |
| | Avg. | 2650 | 1255 | 887 | 406 |
| 12 | 1 | 2900 | 1510 | 1180 | 494 |
| | 2 | 2320 | 1150 | 986 | 429 |
| | Avg. | 2610 | 1330 | 1083 | 462 |
| 13 | 1 | 2850 | 1110 | 994 | 453 |
| | 2 | 2700 | 1690 | 798 | 375 |
| | Avg. | 2775 | 1400 | 896 | 414 |
| 14 | 1 | 4800 | 2610 | 1800 | 628 |
| | 2 | 4830 | 2370 | 1760 | 768 |
| | Avg. | 4815 | 2490 | 1780 | 698 |
| 15 | 1 | 4460 | 2330 | 1860 | 1380 |
| | 2 | 5040 | 2530 | 1750 | 1020 |
| | Avg. | 4750 | 2430 | 1805 | 1200 |
| 16 | 1 | 3410 | 1850 | 1330 | 718 |
| | 2 | 2990 | 1180 | 1240 | 472 |
| | Avg. | 3200 | 1515 | 1285 | 595 |
| 17 | 1 | 3450 | 1520 | 1500 | 863 |
| | 2 | 3460 | 2150 | 1320 | 689 |
| | Avg. | 3455 | 1835 | 1410 | 776 |
| 18 | 1 | 3410 | 2200 | 1260 | 714 |
| | 2 | 3800 | 1720 | 1460 | 817 |
| | Avg. | 3605 | 1960 | 1360 | 766 |

All publications, patents and patent documents are incorporated by reference herein, as though individually incorporated by reference. The invention has been described with reference to specific and preferred embodiments and techniques. However, other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following representative embodiments.

1-20. (canceled)

21. A raw cinnamon roll composition comprising a developed dough layer and a fat component layer, wherein the developed dough comprises:
hard wheat flour,
yeast,
sucrose,
vital wheat gluten, and
monoglyceride.

22. A raw cinnamon roll composition according to claim 21 wherein the developed dough comprises
less than about 10 weight percent corn syrup,
less than about 3 weight percent glycerin, and
less than about 10 weight percent soft wheat flour.

23. A raw cinnamon roll composition according to claim 21 wherein the monohydrate is pre-hydrated, the composition comprising pre-hydrated monoglyceride present in an amount of less than 3.5 percent by weight.

24. A raw cinnamon roll composition according to claim 21 wherein the monohydrate is pre-hydrated, the composition comprising pre-hydrated monoglyceride present in an amount of less than about 2 percent by weight.

25. A raw cinnamon roll composition according to claim 21 comprising vital wheat gluten, present in an amount of less than 5 percent by weight.

26. A raw cinnamon roll composition according to claim 21 comprising yeast, present in an amount in the range from about 1 to 7 percent by weight.

27. A raw cinnamon roll composition of claim 21 wherein the dough contains no glycerin and no soft wheat flour.

28. A raw cinnamon roll composition of claim 21 wherein the dough comprises:
vital wheat gluten, present in an amount of less than 5 percent by weight, and
monoglyceride, present in an amount of less than 3.5 percent by weight.

29. A raw cinnamon roll composition of claim 28 wherein the dough comprises yeast, present in an amount in the range from about 1 to 7 percent by weight.

30. A raw cinnamon roll composition of claim 28 wherein the dough comprises
less than about 2 weight percent glycerine,
less than about 2 weight percent dextrose, and
less than about 2 weight percent corn syrup.

31. A raw cinnamon roll composition of claim 28 wherein the dough comprises
less than about 1 weight percent glycerine,
less than about 1 weight percent dextrose, and
less than about 1 weight percent corn syrup.

32. A raw cinnamon roll composition of claim 28 wherein the roll comprises alternating dough and fat component layers.

33. A raw cinnamon roll composition of claim 32 wherein the roll comprises from about 8 percent to 30 percent fat component.
